(19) United States
(12) Patent Application Publication
(10) Pub. No.: US 2026/0126094 A1
(43) Pub. Date: May 7, 2026

(54) ELECTROHYDRAULIC DAMPER CONTROL VALVE

(71) Applicant: Fox Factory, Inc., Duluth, GA (US)

(72) Inventor: Tyler Eston, Solon, OH (US)

(21) Appl. No.: 18/936,273

(22) Filed: Nov. 4, 2024

(51) Int. Cl. F16F 9/34; F16F 9/32

(52) U.S. Cl. CPC F16F 9/34; F16F 9/3271; F16F 2226/04; F16F 2228/066

(57) ABSTRACT

A high-flow and/or high-pressure electrohydraulic damper control valve is provided. The damper control valve includes an inner housing member and a single piece, stepped spool valve member having a cup shape slidably received about an axially extending cylindrical portion of the inner housing member. At least one window aperture is provided in an upper portion of the single piece, stepped spool valve member. The single piece, stepped spool valve member includes an annular stepped portion between a first inner spool surface portion and a second inner spool surface. An annular surface portion is located on the axially extending cylindrical portion of the inner housing member. The annular stepped portion of the single piece, stepped spool valve member selectively engages the annular surface portion of the inner housing upon movement of the single piece, stepped spool valve member to control hydraulic flow and pressure exposure.

### BACKGROUND OF THE INVENTION

### Technical Field

This invention relates generally to an electrohydraulic damper control valve and more particularly to an electrohydraulic damper control valve for chassis control systems of a vehicle.

### State of the Art

Many high-flow and/or high-pressure electrohydraulic damper control valves tend to be physically large and feature multistage architectures, which can create undesirable ride performance for chassis control systems that experience varied input frequencies and amplitudes over on-road and off-road terrain. Generally, there is an inverse relationship between pressure capability and flow capability for most conventional electrohydraulic valves in order to prevent electrical power needs from increasing. In addition, many of these valve systems are difficult for engineers or technicians to assemble or disassemble, resulting in expensive and time-consuming development activities for custom vehicle applications.

Accordingly, there is a need for an electrohydraulic damper control valve that provides desirable ride performance for chassis control system in a compact, single stage assembly.

### SUMMARY OF THE INVENTION

An embodiment includes a high-flow and/or high-pressure electrohydraulic damper control valve comprising: an inner housing member received within an outer housing member; a single piece, stepped spool valve member having a cup shape slidably received about an axially extending cylindrical portion of the inner housing member; at least one window aperture provided in an upper portion of the single piece, stepped spool valve member; a single, axial inlet opening provided in the inner housing member and extending axially downward into the axially extending cylindrical portion of the inner housing member; a plurality of radially extending inlet openings provided circumferentially about the axially extending cylindrical portion of the inner housing member; and a plurality of outlet openings provided circumferentially about an upper end portion of the outer housing member and about the single piece, stepped spool valve member slidably received on the axially extending cylindrical portion provided with the plurality of radially extending inlet openings.

Another embodiment includes a method of assembling a high-flow and/or high-pressure electrohydraulic damper control valve comprising: providing an inner housing member within an outer housing member; slidably receiving a single piece, stepped spool valve member having a cup shape about an axially extending cylindrical portion of the inner housing member; providing at least one window aperture in an upper portion of the single piece, stepped spool valve member; providing a single, axial inlet opening in the inner housing member and extending axially downward into the axially extending cylindrical portion of the inner housing member; providing a plurality of radially extending inlet openings circumferentially about the axially extending cylindrical portion of the inner housing member; and providing a plurality of outlet openings circumferentially about an upper end portion of the outer housing member and about the single piece, stepped spool valve member slidably received on the axially extending cylindrical portion provided with the plurality of radially extending inlet openings.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a cross sectional view of an electrohydraulic damper control valve, according to an embodiment;

FIG. 2 is a partial cross sectional, perspective view of an electrohydraulic damper control valve, according to an embodiment;

FIG. 3 is a partial cross sectional view of an electrohydraulic damper control valve, according to an embodiment;

FIG. 4 is a perspective view of an inner member of an inner member of an electrohydraulic damper control valve, according to an embodiment;

FIG. 5 is a perspective view of a single piece, stepped spool valve member of an electrohydraulic damper control valve, according to an embodiment; and

FIG. 6 is a block diagram of steps of a method of assembling an electrohydraulic damper control valve, according to an embodiment.

### DETAILED DESCRIPTION OF EMBODIMENTS OF THE INVENTION

As discussed above, embodiments of the present invention relate to an electrohydraulic damper control valve. The present invention allows for independent control of holding pressure and/or flow profile utilizing a stepped spool valve member. The electrohydraulic damper control valve is easily disassembled and reassembled using a limited number of tools. A low total part count and limited number of high-precision parts results in robust operation with reasonable cost.

The stepped spool valve member of the present invention is able to operate as both a pressure control valve and/or a flow control valve depending on the electrical power applied to the adjacent linear solenoid. Holding pressure capability is proportional to the annular area of the spool step. Force applied from the linear armature member acts to change performance characteristics as a function of applied electrical power.

The stepped spool valve of the present invention may be scaled to different overall sizes and power requirements and applied to any application of semi-active hydraulic dampers. The stepped spool valve of the present invention is configured to act on rod-displaced flow of almost any size.

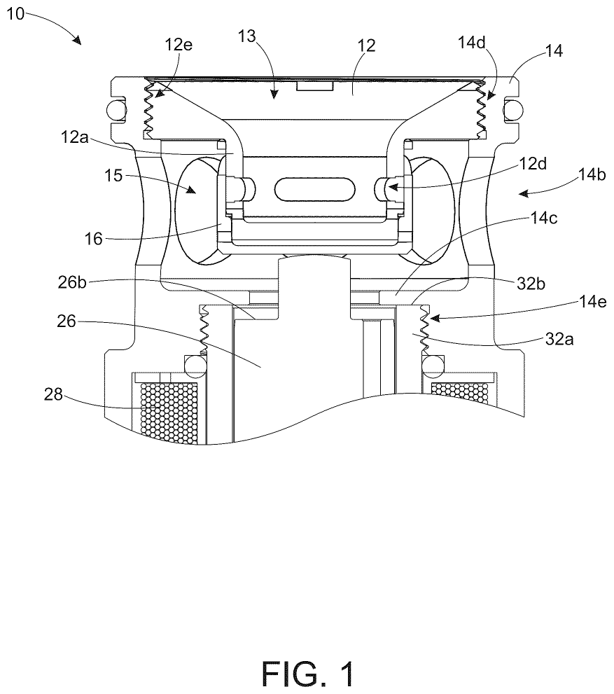

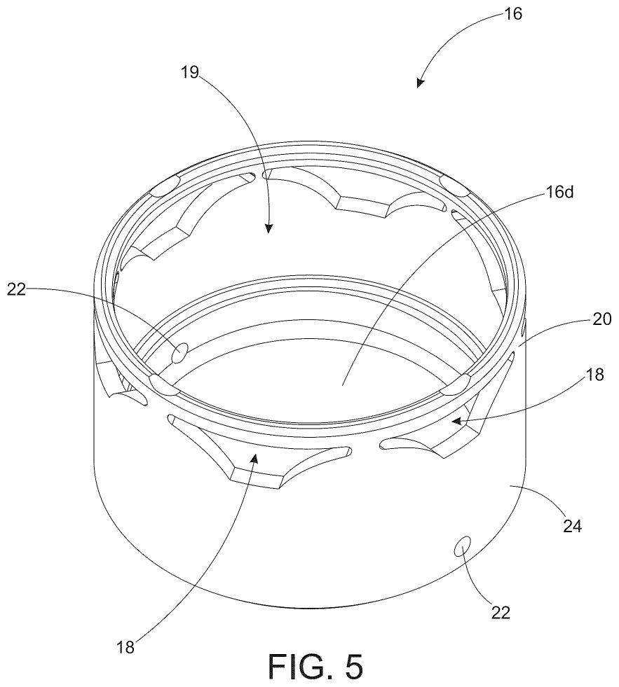

Referring to FIGS. 1-5, a high-flow and/or high-pressure electrohydraulic damper control valve 10 is provided with an inner housing member 12 and an outer housing member 14. The inner housing member 12 is provided with an upper outer threaded portion 12e and is directly threaded into an upper inner threaded portion 14d provided on an upper end portion 14b of the outer housing member 14. A single piece, stepped spool valve member 16, having a cup shape with an inner volume 19, is slidably received about an axially extending cylindrical portion 12a of the inner housing member 12. The inner housing member 12 is provided with a single, axial inlet opening 13 extending axially downward into the axially extending cylindrical portion 12a of the inner housing member 12. A plurality of radially extending inlet openings 12d is provided circumferentially about the axially extending cylindrical portion 12a of the inner housing member 12. A plurality of outlet openings 15 is provided circumferentially about the upper end portion 14b of the outer housing member 14.

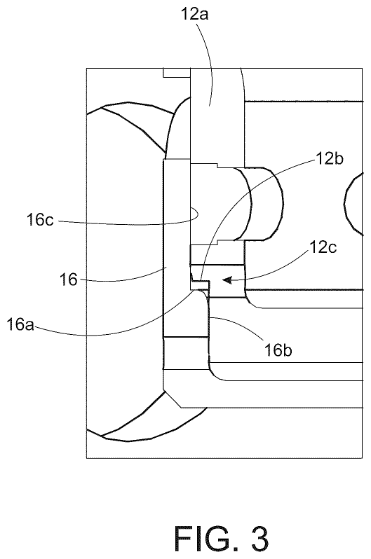

An annular stepped portion 16a is provided between a first inner spool surface portion 16b and a second inner spool surface portion 16c (See FIGS. 3-5) of the single piece, stepped spool valve member 16 and is fundamentally acted upon by hydraulic pressure to articulate axial motion. An annular surface 12b is provided on the axially extending cylindrical portion 12a of the inner housing member 12. The annular stepped portion 16a selectively engages the annular surface portion 12b upon movement of the single piece, stepped spool valve member 16, which controls hydraulic flow exposure. The inner housing member 12 comprises feed ports 12c that extend through the axially extending cylindrical portion 12a and is located below the plurality of radially extending inlet openings 12d. The feed ports 12c are located such that the circumference of the feed ports extend above and below the annular surface portion 12b. This allows hydraulic fluid that enters the inner housing member 12 through the axial inlet opening 13 to flow through the feed ports 12c and engage and act upon the annular stepped portion 16a of the single piece, stepped spool valve member 16. The inner housing member 12 may include two or more feed ports 12c that are equally spaced around the circumference of the inner housing 12 to balance the pressure of the hydraulic pressure acting on the annular stepped portion 16a of the single piece, stepped spool valve member 16 and ensure proper axial movement of the single piece, stepped spool valve member 16.

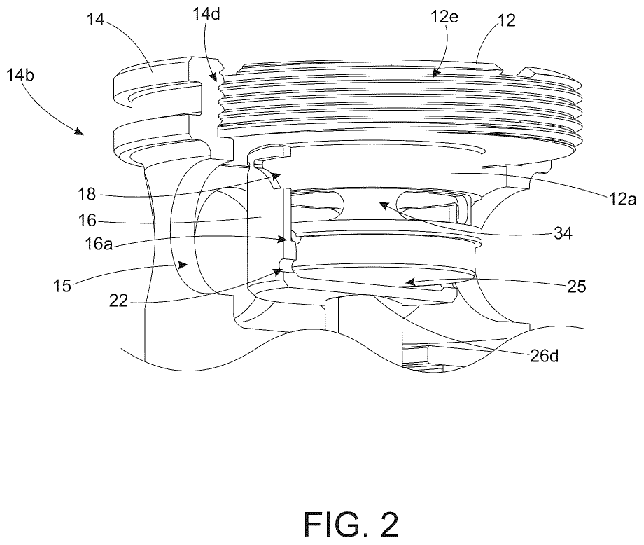

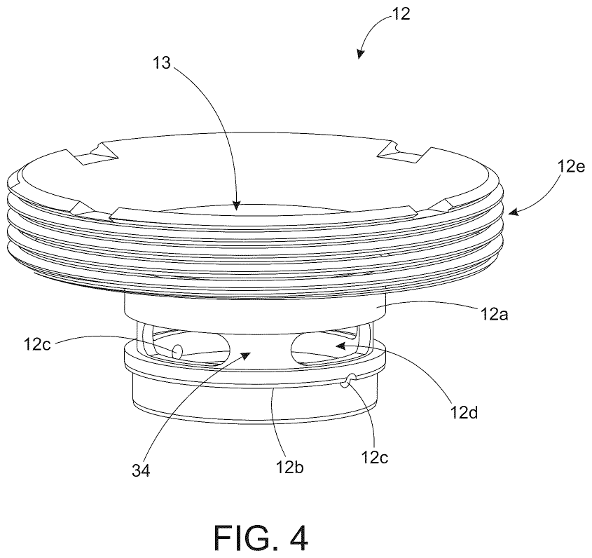

At least one window aperture 18 is provided in an upper portion 20 of the single piece, stepped spool valve member 16 (FIGS. 2 and 4). The at least one window aperture 18 may be cylindrical, triangle shaped, or any other profile. Pressure balancing ports 22 are provided in a lower portion 24 of the single piece, stepped spool valve member 16 and communicate with a chamber 25 between the axially extending cylindrical portion 12a of the inner housing member 12 and a bottom end 16d of the single piece, stepped spool valve member 16.

A reciprocating armature member 26 is provided within an electromagnetic coil member 28 positioned within the outer housing member 14 of the electrohydraulic damper control valve 10. The reciprocating armature member 26 may be axially biased upward by a spring member (not shown).

An armature housing member 32 is coaxially arranged about the reciprocating armature member 26. The armature housing member 32 may separate the reciprocating armature member 26 from the electromagnetic coil member 28. A threaded upper end portion 32a of the armature housing member 32 may be received within an inner threaded portion 14e provided within the upper end portion 14b of the outer housing member 14.

An inwardly extending annular flange portion 14c may abut an annular surface portion 32b of the upper end portion 32a of the armature housing member 32. The inwardly extending annular flange portion 14c may extend over an upper annular surface portion 26b of the reciprocating armature member 26 in order to inhibit movement of the reciprocating armature member 26 out of the armature housing member 32 once the inner housing member 12 and the single piece, stepped spool valve member 16 are removed from the outer housing member 14.

During operation, the hydraulic pressure differential between the single, axial inlet opening 13 and the plurality of outlet openings 15 acts only to imbalance the annular stepped portion 16a, allowing for precise control of the annular stepped portion 16a and therefore the holding pressure without adjusting the flow profile. The at least one window aperture 18 is oriented around the circumference of the single piece, stepped spool valve member 16 to allow for precise control of the flow profile as the single piece, stepped spool valve member 16 opens and closes the at least one window aperture 18.

The single piece, stepped spool valve member 16 is positioned to redirect flow through the at least one window aperture 18 in such a way as to counteract viscous flow effects at high flow rates through the at least one window aperture 18, such as, but not limited to, reducing auto-close behavior caused by a pressure drop due to the high flow rate through the window aperture 18. The pressure balancing ports 22, which pressure-balance the chamber 25 between the axially extending cylindrical portion 12a of the inner housing member 12 and the bottom end 16d of the single piece, stepped spool valve member 16 may also be tuned and restricted to act as hydraulic dampers of the single piece, stepped spool valve member 16 during opening and closing of the at least one window aperture 18. Adjustments to both the sizes and positioning of the pressure balancing ports 22 allow for precise tuning of the hydraulic damper control valve 10 stability and response characteristics. The number of pressure balancing ports 22 may be two or more pressure balancing ports 22 that are equally spaced around the circumference of the single piece, stepped spool valve member 16 to balance the pressure between the axially extending cylindrical portion 12a of the inner housing member 12 and the bottom end 16d of the single piece, stepped spool valve member 16 and ensure proper axial movement of the single piece, stepped spool valve member 16. Proper axial movement of the single piece, stepped spool valve member 16 includes movement axially without misalignments that would inhibit axial movement of the single piece, stepped spool valve member 16.

Referring to FIGS. 1 and 2, inner housing member 12 is threaded directly into the outer housing member 14. Assembly and disassembly may be easily performed with only one tool. Disassembly does not allow the reciprocating armature member 26 to become unretained. All components of the reciprocating armature member 26 and the electromagnetic coil member 28 remain fully captured during tuning or development. A prechamber 34 allows for independent clocking of the inner housing member 12 and the single piece, stepped spool valve member 16 without affecting flow characteristics. Both the inner housing member 12 and the single piece, stepped spool valve member 16 can be swapped together or independently within seconds and do not require handling or resetting of a coil member.

The reciprocating armature member 26, once installed, applies motor and spring force to the single piece, stepped spool valve member 16 on one end 16d. Armature contact surface 26d of armature member 26 may be spherically shaped in order to compensate for any axial misalignment within the assembly in order to apply force against the single piece, stepped spool valve member 16 without any bending component.

FIGS. 1-3 depict a normally closed (NC) configuration, where a no-power state results in the highest holding pressure. In another embodiment (not shown), the present invention may be configured to operate in a normally open (NO) configuration by relocating the spring member (not shown) and repositioning the electromagnetic coil member 28 relative to the reciprocating armature member 26.

In another embodiment, the present invention may operate with no annular stepped portion 16a (not shown). In an embodiment with no annular stepped portion 16a (not shown), the single piece, stepped spool valve member 16 will act purely as a flow control valve, wherein the input/output pressure differential has no effect on the opening action of the single piece, stepped spool valve member 16.

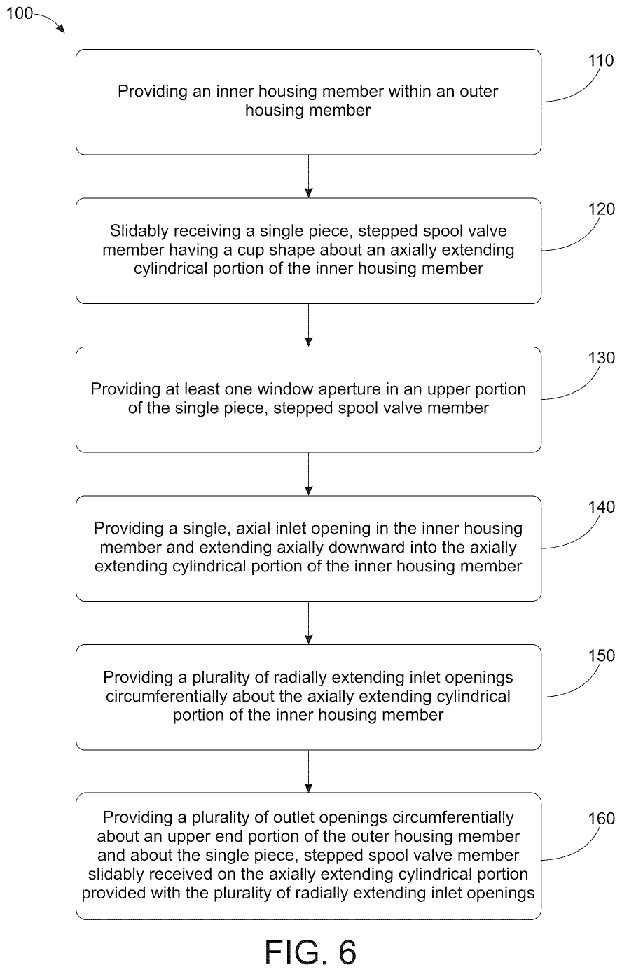

FIG. 6 is a block diagram of steps of a method 100 of assembling a high-flow and/or high-pressure electrohydraulic damper control valve. Method 100 comprises providing an inner housing member within an outer housing member (Step 110); slidably receiving a single piece, stepped spool valve member having a cup shape about an axially extending cylindrical portion of the inner housing member (Step 120); providing at least one window aperture in an upper portion of the single piece, stepped spool valve member (step 130); providing a single, axial inlet opening in the inner housing member and extending axially downward into the axially extending cylindrical portion of the inner housing member (step 140); providing a plurality of radially extending inlet openings circumferentially about the axially extending cylindrical portion of the inner housing member (Step 150); and providing a plurality of outlet openings circumferentially about an upper end portion of the outer housing member and about the single piece, stepped spool valve member slidably received on the axially extending cylindrical portion provided with the plurality of radially extending inlet openings (Step 160).

The method may further comprise providing an annular stepped portion between a first inner spool surface portion and a second inner spool surface portion of the single piece, stepped spool valve member. The method may further comprise providing an annular surface portion on the axially extending cylindrical portion of the inner housing member.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A high-flow and/or high-pressure electrohydraulic damper control valve comprising:
an inner housing member received within an outer housing member;
a single piece, stepped spool valve member having a cup shape slidably received about an axially extending cylindrical portion of the inner housing member;
at least one window aperture provided in an upper portion of the single piece, stepped spool valve member;
a single, axial inlet opening provided in the inner housing member and extending axially downward into the axially extending cylindrical portion of the inner housing member;
a plurality of radially extending inlet openings provided circumferentially about the axially extending cylindrical portion of the inner housing member; and
a plurality of outlet openings provided circumferentially about an upper end portion of the outer housing member and about the single piece, stepped spool valve member slidably received on the axially extending cylindrical portion provided with the plurality of radially extending inlet openings.

2. The electrohydraulic damper control valve of claim 1, wherein the single piece, stepped spool valve member comprises an annular stepped portion provided between a first inner spool surface portion and a second inner spool surface portion.

3. The electrohydraulic damper control valve of claim 2, wherein the inner housing member comprises an annular surface portion provided on the axially extending cylindrical portion.

4. The electrohydraulic damper control valve of claim 3, wherein the annular stepped portion of the single piece, stepped spool valve member selectively engages the annular surface portion of the inner housing upon movement of the single piece, stepped spool valve member.

5. The electrohydraulic damper control valve of claim 4, wherein the inner housing member comprises feed ports that extend through the axially extending cylindrical portion and are located below the plurality of radially extending inlet openings.

6. The electrohydraulic damper control valve of claim 5, wherein the feed ports are located in the inner housing such that a circumference of the feed ports extend above and below the annular surface portion of the inner housing.

7. The electrohydraulic damper control valve of claim 6, wherein the feed ports are configured to allow hydraulic fluid that enters the inner housing member through the axial inlet opening to flow through the feed ports and engage and act upon the annular stepped portion of the single piece, stepped spool valve member.

8. The electrohydraulic damper control valve of claim 7, wherein the feed ports are equally spaced around the circumference of the inner housing to balance the pressure of the hydraulic pressure acting on the annular stepped portion of the single piece, stepped spool valve member.

9. The electrohydraulic damper control valve of claim 1, wherein a circumferential prechamber is disposed about the plurality of radially extending inlet openings provided circumferentially about the axially extending cylindrical portion of the inner housing member.

10. The electrohydraulic damper control valve of claim 1, further comprising pressure balancing ports provided in a lower portion of the single piece, stepped spool valve member.

11. The electrohydraulic damper control valve of claim 10, wherein the pressure balancing ports communicate with a chamber between the axially extending cylindrical portion of the inner housing member and a bottom end of the single piece, stepped spool valve member.

12. The electrohydraulic damper control valve of claim 11, wherein the pressure balancing ports are equally spaced around the circumference of the single piece, stepped spool valve member to balance the pressure between the axially extending cylindrical portion of the inner housing member and the bottom end of the single piece, stepped spool valve member.

13. The electrohydraulic damper control valve of claim 12, wherein the pressure balancing ports are equally spaced around the circumference of the single piece, stepped spool valve member to ensure axial movement of the single piece, stepped spool valve member while limited axial misalignment of the single piece, stepped spool valve member.

14. The electrohydraulic damper control valve of claim 1, wherein the inner housing member is provided with an upper outer threaded portion and is directly threaded into an upper inner threaded portion provided on the upper end portion of the outer housing member.

15. The electrohydraulic damper control valve of claim 1, wherein a reciprocating armature member is provided within an electromagnetic coil member positioned within the outer housing member, wherein the reciprocating armature member is configured to engage the single piece, stepped spool valve member.

16. A method of assembling a high-flow and/or high-pressure electrohydraulic damper control valve comprising:
providing an inner housing member within an outer housing member;
slidably receiving a single piece, stepped spool valve member having a cup shape about an axially extending cylindrical portion of the inner housing member;
providing at least one window aperture in an upper portion of the single piece, stepped spool valve member;
providing a single, axial inlet opening in the inner housing member and extending axially downward into the axially extending cylindrical portion of the inner housing member;
providing a plurality of radially extending inlet openings circumferentially about the axially extending cylindrical portion of the inner housing member; and
providing a plurality of outlet openings circumferentially about an upper end portion of the outer housing member and about the single piece, stepped spool valve member slidably received on the axially extending cylindrical portion provided with the plurality of radially extending inlet openings.

17. The method of assembling according to claim 16, further comprising providing an annular stepped portion between a first inner spool surface portion and a second inner spool surface portion of the single piece, stepped spool valve member.

18. The method of assembling according to claim 17, further comprising providing an annular surface portion on the axially extending cylindrical portion of the inner housing member, wherein the annular stepped portion of the single piece, stepped spool valve member selectively engages the annular surface portion of the inner housing upon movement of the single piece, stepped spool valve member.
